(19) United States
(12) Patent Application Publication
(10) Pub. No.: US 2013/0214493 A1
(43) Pub. Date: Aug. 22, 2013

(54) VEHICLE PISTON RING HAVING MULTI-LAYER COATING

(71) Applicants: Sung Chul Cha, Seoul (KR); Chang Hyun Shin, Incheon (KR); Ji Hwan Yun, Ansan (KR)

(72) Inventors: Sung Chul Cha, Seoul (KR); Chang Hyun Shin, Incheon (KR); Ji Hwan Yun, Ansan (KR)

(73) Assignees: KIA MOTORS CORPORATION, Seoul (KR); HYUNDAI MOTOR COMPANY, Seoul (KR)

(21) Appl. No.: 13/482,132

(22) Filed: May 29, 2012

(30) Foreign Application Priority Data
Feb. 20, 2012 (KR) 10-2012-0016764

(51) Int. Cl. F16J 9/26

(52) U.S. Cl. 277/442

(57) ABSTRACT

Disclosed is a piston ring having a multi-layer coating. The piston ring includes a buffer layer, a intermediate layer, a TiAlN/CrN nano multilayer, and a TiAlCN layer. The buffer layer is coated over a base material of a piston ring. The intermediate layer is coated over the buffer layer. The TiAlN/CrN nano multilayer is coated over the intermediate layer. The TiAlCN layer is coated over the TiAlN/CrN nano multilayer as an outermost surface layer.

### CROSS-REFERENCE TO RELATED APPLICATION

This application claims under 35 U.S.C. §119(a) the benefit of Korean Patent Application No. 10-2012-0016764 filed Feb. 20, 2012, the entire contents of which are incorporated herein by reference.

### BACKGROUND

(a) Technical Field

The present invention relates to a vehicle piston ring having a multi-layer coating. More particularly, it relates to a vehicle piston ring having a multi-layer coating, in which a to TiAlCN layer is coated on the outer circumferential surface of the base material of a piston ring to increase the abrasion lifespan of the piston ring and improve fuel efficiency due to reduction of a frictional loss between an engine cylinder and the piston ring.

### (b) Background Art

Recently, “eco-friendly” vehicles have become the megatrend of next-generation vehicle development by the automobile industry, and various eco-friendly vehicles are being developed with the goal of reducing CO₂ emissions to about 50 g/km by 2020, which is about a 35% to 50% reduction compared to current emission levels. Also, vehicle manufacturers are trying to develop technologies for improving vehicle fuel efficiency to meet the 54.5 mpg (23.2 km/1) goal mandated by U.S. Corporate Average Fuel Economy (CAFE) for implementation by 2025. Thus, in order to increase the fuel efficiency in driving systems such as engines, there is a need for engine parts having functional characteristics such as low friction, abrasion resistance and heat resistance.

As shown in FIG. 7, a piston ring maintains airtightness between a piston and the inner wall of an engine cylinder. Piston rings fit into a groove on the outer diameter of a piston to scrape a lubricant from the inner wall of the engine cylinder so that the lubricant does not enter the combustion chamber. Accordingly frictional loss and abrasion occurs in the cylinder due to the reciprocating movement of the cylinders against the rings. Thus, various coating and surface treatments with low friction and high endurance are being applied to the outer circumferential surface of the piston rings in an effort to reduce the amount of to abrasion and friction loss.

For example Cr plating and nitriding (gas nitriding) may be applied to the outer circumferential surface of the piston ring to reduce abrasion resistance. This solution, however, does not address friction loss. Recently, various coating materials such as Diamond Like Carbon (DLC) and CrN are being used for low friction and endurance improvement.

In particular, as shown in FIG. 6, CrN is coated on the base material surface of a piston ring by a Physical Vapor Deposition (PVD) method, and is partially applied to the outer circumferential surface of the piston ring because its low friction, abrasion resistance, and scuff resistance are better than those in Cr plating and nitriding.

However, although DLC has excellent low friction and high hardness characteristics, hydrogen in DLC may be effused in an atmosphere of moisture and friction at a high temperature of about 300° C., thereby softening the DLC coating and deteriorating its friction resistance and durability.

Accordingly, there is a need for a coating for engine parts that overcomes these deficiencies in the conventional art.

### SUMMARY OF THE DISCLOSURE

The present invention provides a vehicle piston ring with a multi-layer coating, which can secure heat resistance against a temperature of about 500° C. or more, abrasion resistance, and low friction characteristics using a coating structure in which TiAlCN containing carbon with low friction characteristics is coated as the outermost surface layer and TiAlN/CrN containing heat-resistance elements (e.g., TiAl and Cr) with excellent heat resistance and abrasion resistance and having excellent toughness is coated as an intermediate layer.

In one aspect, the present invention a vehicle piston ring having a multi-layer coating, including: a Cr or Ti buffer layer coated over a base material of a piston ring; a CrN or Ti(C)N intermediate layer coated over the Cr or Ti buffer layer; a TiAlN/CrN nano multilayer coated over the CrN or Ti(C)N intermediate layer; and a TiAlCN layer coated over the TiAlN/CrN nano multilayer as an outermost surface layer.

In an exemplary embodiment, the Cr or Ti buffer layer may be formed to have a thickness of about 0.01 μm to about 0.5 μm, and the CrN or Ti(C)N intermediate layer may be formed to have a thickness of about 0.1 μm to about 5 μm.

In another exemplary embodiment, the TiAlN/CrN nano layer may include TiAlN and CrN that are alternately coated to form a multilayer.

In still another exemplary embodiment, the TiAlN/CrN nano layer may include TiAlN nano layers with a thickness of about 10 nm to about 50 nm and CrN nano layers with a thickness of about 10 nm to about 50 nm which are alternately coated to form a thickness of about 0.1 μm to about 10 μm.

In yet another exemplary embodiment, the TiAlCN layer may be formed to have a thickness of about 0.1 μm to about 10 μm.

In still yet another exemplary embodiment, the TiAlCN layer may include carbon of about 5 atomic percent (at. %) to about 30 at. %.

Other aspects and exemplary embodiments of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a view illustrating a nano multi-layer coating of a vehicle piston ring according to an embodiment of the present invention;

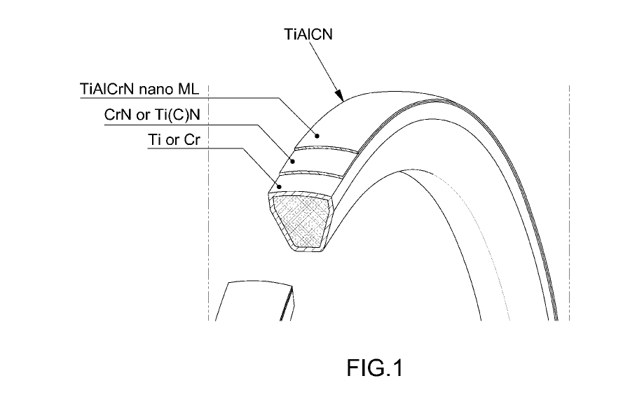

FIG. 2 is a view illustrating a stacked structure of a nano multi-layer coating of a vehicle piston ring according to an embodiment of the present invention;

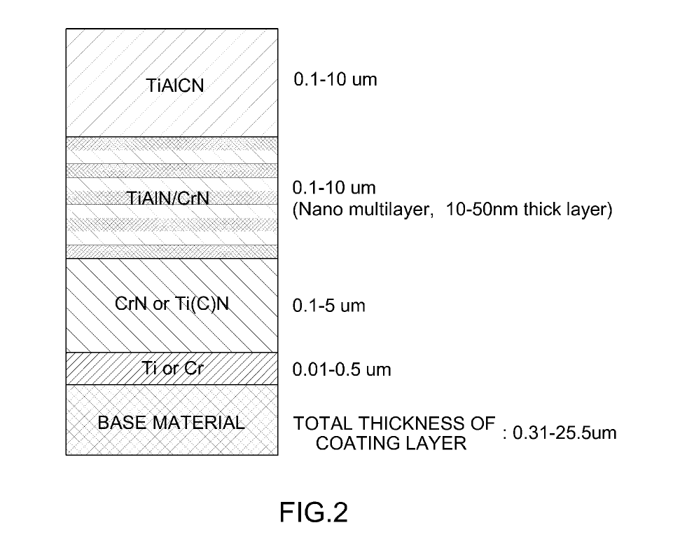

FIG. 3 is a view illustrating a Physical Vapor Deposition (PVD) apparatus for forming a nano multi-layer coating on a vehicle piston ring according to an embodiment of the present invention;

FIGS. 4 and 5 are electron microscopic views illustrating a texture of a nano multi-layer coating of a vehicle piston ring according to an embodiment of the present to invention;

FIG. 6 is a view illustrating a typical method for treating and coating the surface of a piston ring; and

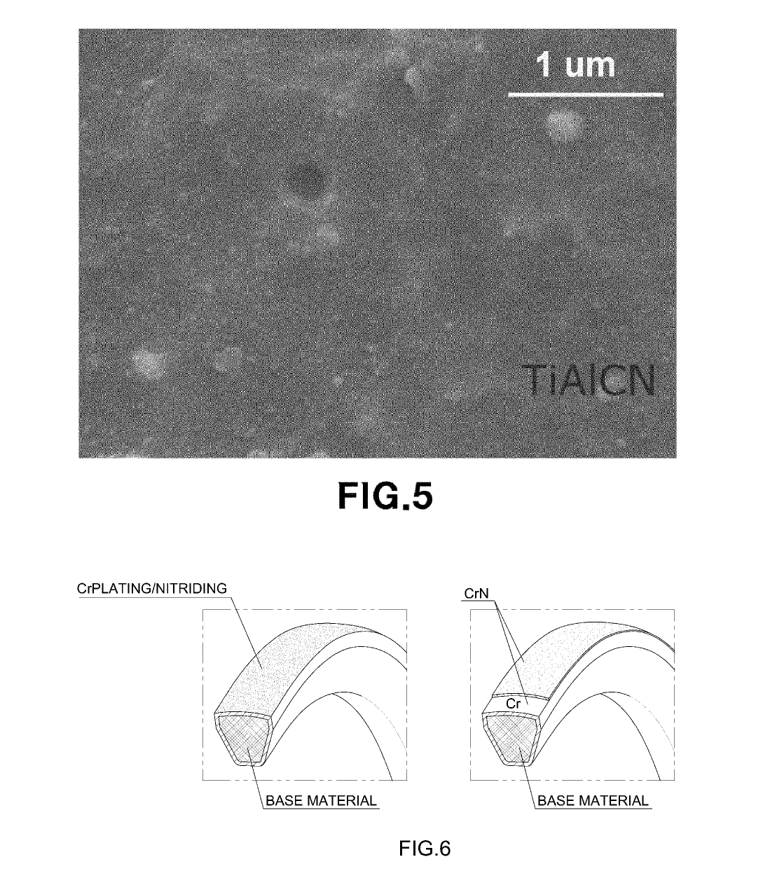

FIG. 7 is a view illustrating a mounting location of a piston ring among vehicle parts.

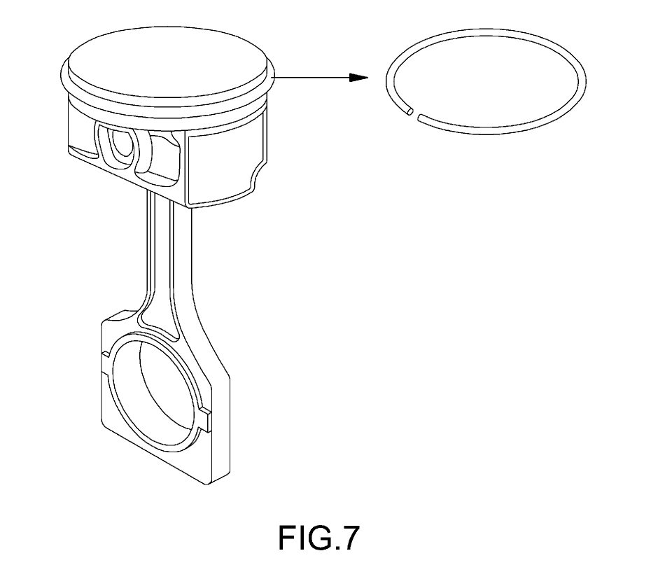

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Ranges provided herein are understood to be shorthand for all of the values within the range. For example, a range of 1 to 50 is understood to include any number, combination of numbers, or sub-range from the group consisting of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50, as well as all intervening decimal values between the aforementioned integers such as, for example, 1.1, 1.2, 1.3, 1.4, 1.5, 1.6, 1.7, 1.8, and 1.9. With respect to sub-ranges, “nested sub-ranges” that extend from either end point of the range are specifically contemplated. For example, a nested sub-range of an exemplary range of 1 to 50 may comprise 1 to 10, 1 to 20, 1 to 30, and 1 to 40 in one direction, or 50 to 40, 50 to 30, 50 to 20, and 50 to 10 in the other direction.

The above and other features of the invention are discussed infra.

Hereinafter, exemplary embodiments of the present invention will be described in detail with reference to the accompanying drawings.

The present invention provides a piston ring for an engine in a vehicle that enables about 30% friction reduction, about 0.5% fuel efficiency improvement, about 54% scuff resistance improvement, and about 90% abrasion resistance improvement compared to an uncoated piston ring (nitriding).

For this, a Ti or Cr buffer layer, a CrN or Ti(C)N intermediate layer, a TiAlN/CrN nano multilayer, and a TiAlCN layer that is the outermost surface layer may be sequentially coated over an outer circumferential surface of a base material of the piston ring through a Physical Vapor Deposition (PVD) method.

PVD is a general term used to describe any of a variety of methods used in the art to deposit thin films. PVD is typically done by depositing the condensation of a vaporized form of the desired film material onto various surfaces. Typically, PVD involves purely physical processes such as high temperature vacuum evaporation with subsequent condensation, or plasma sputter bombardment rather than involving a chemical reaction at the surface to be coated as in chemical vapor deposition. Some examples, of PVD include cathodic Arc Deposition, electron beam physical vapor deposition, evaporative deposition, pulsed laser deposition, sputter deposition, etc.

Using one of the PVD methods described above, the Cr or Ti buffer layer may be coated on the surface of the base material of the piston ring in a thickness of about 0.01 μm to about 0.5 μm. The CrN or Ti(C)N intermediate layer may be coated on the Cr or Ti buffer layer in a thickness of about 0.1 μm to about 5 μm. The TiAlN/CrN nano multilayer may be coated on the CrN or Ti(C)N intermediate layer in a thickness of about 0.1 μm to about 10 μm. The TiAlCN layer that is the outermost surface layer may be coated on the TiAlN/CrN nano multilayer in a thickness of about 0.1 μm to about 10 μm.

Hereinafter, the functions of each layer coated over the piston ring will be described as follows.

Cr or Ti Buffer Layer

The Cr or Ti buffer layer preferably should have excellent bonding strength with the base material of the piston ring, and may serve to reduce and control the residual stress of other coating layers. In order to achieve such a function, the Cr or Ti buffer layer may be coated on the surface of the base material of the piston ring in a thickness of about 0.01 μm to about 0.5 μm.

CrN or Ti(C)N Intermediate Layer

The CrN or Ti(C)N intermediate layer may be coated on the Cr or Ti buffer layer in a thickness of about 0.1 μm to about 5 μm to perform its functions such as toughness, fatigue resistance, and shock resistance.

TiAlN/CrN Nano Multilayer

The TiAlN/CrN nano multilayer may contain heat-resistance elements (e.g., TiAl and Cr) with excellent heat resistance and abrasion resistance, and may include TiAlN and CrN nano layers that are alternately coated on the surface of the CrN or Ti(C)N intermediate layer to provide improved toughness. The TiAlN and CrN nano layers with a thickness of about 10 nm to about 50 nm may be alternately coated to form a total thickness of about 0.1 μm to about 10 μm.

TiAlCN Layer

The TiAlCN layer may further include carbon (C) of about 5 at. % to about 30 at. % with excellent low friction characteristics in addition to the components constituting the above nano multilayer, and may form the outermost surface layer. The TiAlCN layer may have a total thickness of about 0.1 μm to about 10 μm.

Hereinafter, a method of coating a vehicle piston ring according to an embodiment of the present invention will be described as follows.

The piston ring having a nanostructure multilayer may be formed by a Physical Vapor Deposition (PVD) method. In addition, High Power Impulse Magnetron Sputtering to (HIPIMS), Inductively Coupled Plasma (ICP) Magnetron Sputtering, and arch methods for generating high density plasma to implement nanosizing of coating material particles and high speed coating may be used.

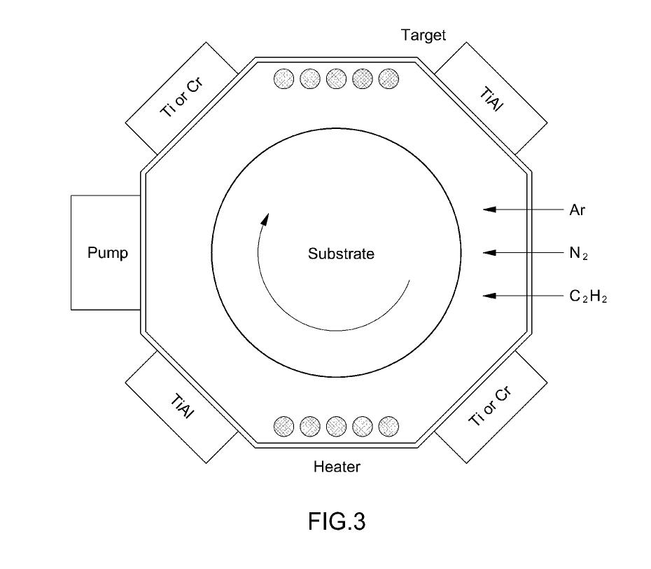

FIG. 3 illustrates a PVD coating apparatus for coating a nano multilayer on a piston ring according to an embodiment of the present invention. The PVD coating apparatus may include a pair of Ti or Cr targets opposite to each other, a pair of TiAl targets opposite to each other, and a gas supply unit for supplying Ar, N₂ and hydrocarbon process gases.

For a coating processing using the PVD coating apparatus, in a vacuum state prior to coating, a plasma state may be prepared using Ar gas. Thereafter, a coating chamber may be heated to a temperature of about 80° C. to activate the surface of the piston ring, and then the surface of the piston ring may be cleaned by applying a bias while allowing Ar ions to collide with the surface of the piston ring (baking & cleaning).

Next, in order to provide increased bonding strength with the base material of the piston ring and reduce the residual stress of coating, a Ti or Cr layer may be coated on the base material surface of the piston ring in a thickness of about 0.01 μm to about 0.5 μm using only the Ti or Cr targets.

A CrN layer is then formed by providing process gas N₂ to react with Cr ions from the Cr target, or a TiN or TiCN layer formed by flowing C₂H₂ and N₂ to react with Ti ions from the Ti target may be coated on the surface of the Ti or Cr layer in a thickness of about to 0.1 μm to about 5 μm to form an intermediate layer that improves toughness, fatigue resistance and shock resistance, a

Next, a TiAlN/CrN nano multilayer containing heat-resistance elements (e.g., TiAl and Cr) with excellent heat resistance and abrasion resistance and having excellent toughness may be coated on the TiN or TiCN layer. In this case, the TiAlN nano layer and the CrN nano layer having a thickness of about 10 nm to about 50 nm may be alternately coated using the TiAl target, the Cr target, and the process gas N₂ to form a total thickness of about 0.1 μm to about 10 μm.

Next, the TiAlCN containing about 5 at. % to about 30 at. % of carbon (C) with excellent friction characteristics may be coated on the outermost surface of the TiAlN/CrN nano layer. The TiAlCN layer may be formed on the outermost surface of the TiAlN/CrN nano layer in a thickness of about 0.1 μm to about 10 μm using the TiAl target and the process gases C₂H₂ and N₂.

In this case, when the content of carbon contained in the TiAlCN layer is less than about 5 at. %, the TiAlCN layer may be changed into a crystalline or polycrystalline texture to reduce the hardness of the layer. However, when the content of carbon is equal to or greater than about 30 at. %, the TiAlCN layer may be changed into an amorphous texture to also reduce the hardness of the layer.

Hereinafter, an exemplary embodiment of the present invention will be described in more detail.

### Embodiment

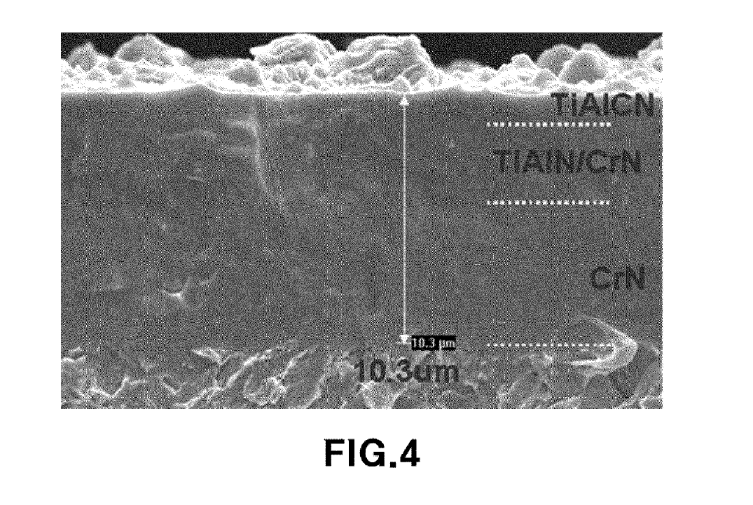

As shown in Table 1 below, a Cr buffer layer having a thickness of about 0.3 μm was coated on the surface of the base material of a piston using a PVD method, and then a CrN intermediate layer having a thickness of about 6 μm was coated on the Cr buffer layer. Thereafter, a TiAlCrN nano multilayer having a thickness of about 3 μm was coated on the CrN intermediate layer, and then a TiAlCN layer was coated thereon as the outermost surface layer. The coating texture is shown in FIGS. 4 and 5.

TABLE 1

| | Comparative | Comparative | Comparative | |
|---|---|---|---|---|
| | Example 1 | Example 2 | Example 3 | Embodiment |
| Surface | Nitriding | CrN | DLC | TiAlCN |
| treatment/coating | | | | |
| Method | — | PVD | PVD | PVD |
| Thickness | 20 | 5 | 2.1 | 10.3 |
| | | | (0.1Cr—0.5WC-1.5DLC) | (0.3Cr—6CrN—3TiAlCrN—1TiAlCN) |

### Comparative Examples 1 to 3

As shown in Table 1, in a comparative example 1, a nitride layer having a thickness of about 20 μm was formed on the base material of a piston ring using a nitriding method for the comparative example 1. In a comparative example 2, CrN having a thickness of about 5 μm was coated on the base material surface of the piston ring by the PVD method. In a comparative example 3, a DLC coating layer (0.1Cr-0.5WC-1.5DLC) was coated in a thickness of about 2.1 μm by the PVD method.

### Test Examples 1 to 4

As a test example 1, the friction coefficient between a cylinder liner and coated to piston rings of the embodiment and the comparative examples 1 to 3 was measured using a reciprocating friction/abrasion tester. The test was performed for about one hour an oil condition load of about 150 N, temperature of about 150° C., and reciprocating period of about 5 Hz.

As a test example 2, a scuffing generation load between a cylinder liner and coated piston rings of the embodiment and the comparative examples 1 to 3 was measured using a reciprocating friction/abrasion tester, and resistances against oil film destruction were compared to compare scuff resistances. The test was performed under a oil condition increasing load to about 500 N by 20 N every 20 minutes, temperature of about 150° C., and reciprocating period of about 5 Hz.

As a test example 3, for a comparison of high-temperature abrasion resistances between a cylinder liner and coated piston rings of the embodiment and the comparative examples 1 to 3, the amount of abrasion was measured using the reciprocating friction/abrasion tester. The test was performed for about one hour under an oil condition load of about 150 N, temperature of about 200° C. and reciprocating period of about 5 Hz.

As a test example 4, the bonding strength and the hardness of the respective coating layers of the piston ring according to the embodiment and the comparative examples 1 to 3 were measured using typical equipment.

The measurement results of the test examples 1 to 4 are shown in Table 2 below.

TABLE 2

| | Comparative | Comparative | Comparative | |
|---|---|---|---|---|
| | Example 1 | Example 2 | Example 3 | Example |
| Surface | Nitriding | CrN | DLC | TiAlCN |
| treatment/coating | | | | |
| Friction | 0.11 | 0.095 | 0.09 | 0.077 |
| coefficient (—) | | | | |
| Scuffing load (N) | 220 | 340 | 440 | 480 |
| High-temperature | 2.0 | 0.7 | 1.6 | 0.2 |
| abrasion | | | | |
| resistance | | | | |
| (μm/100 h) | | | | |
| Bonding strength | — | 44 | 40 | 49 |
| (N) | | | | |
| Hardness (HV) | 1,000 | 2,524 | 3,142 | 2,956 |

As shown in Table 2, the friction coefficient and the high-temperature abrasion resistance of the piston ring according to the embodiment of the present invention are better than those of the comparative examples 1 to 3. Also, since the scuffing load was measured to be about 480 N when the oil film is broken, the scuffing load of the Example was better than those of the comparative examples 1 to 3, and the bonding strength and the hardness of the Example were better than the comparative examples 1 to 3.

According to embodiments of the present invention, the present invention provides the following effects.

Heat resistance against a temperature of about 500° C. or more, abrasion resistance, and low friction characteristics can be simultaneously secured by providing a piston ring in which a Cr or Ti buffer layer and a CrN or Ti(C)N intermediate layer on a base material of the piston ring are sequentially coated, a TiAlN/CrN nano layer containing heat-resistance elements (e.g., TiAl and Cr) with excellent heat resistance and abrasion resistance and having excellent toughness is coated on the CrN or Ti(C)N intermediate layer, and then a TiAlCN layer containing carbon with excellent low friction characteristics is coated as the outermost surface layer.

Since the friction coefficient of TiAlCN is lowered by about 30% and about 19% than nitriding and CrN, respectively, reduction of frictional loss of a piston ring and fuel efficiency improvement (e.g., about 0.2% to about 0.5%) can be achieved.

Also, since the scuff resistance of TiAlCN is better by about 54% and about 29% than nitriding and CrN, respectively, the oil film destruction can be inhibited, and the durability can be improved. Further, since the abrasion resistance of TiAlCN is better by about 90% and about 70% than nitriding and CrN, respectively, and a TiAlCrN multilayered structure exists thereunder as an intermediate layer, the durability of a piston ring can be secured.

In addition, as elements with excellent heat resistance against a high temperature of about 500° C. are coated, limitations in the heat resistance of typical DLC and deficiency in low friction characteristics of CrN can be overcome as well.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. A piston ring having a multi-layer coating, comprising:
a buffer layer including Cr or Ti coated over a base material of the piston ring;
an intermediate layer including CrN or Ti(C)N coated over the buffer layer;
a TiAlN/CrN nano multi-layer coated over the intermediate layer; and
a TiAlCN layer coated over the TiAlN/CrN nano multilayer to form an outermost surface layer of the piston ring.

2. The vehicle piston ring of claim 1, wherein the buffer layer is formed to have a thickness of at least about 0.01 μm to about 0.5 μm, and the intermediate layer is formed to have a thickness of at least about 0.1 μm to about 5 μm.

3. The vehicle piston ring of claim 1, wherein the TiAlN/CrN nano multi-layer contains TiAlN and CrN that are alternately coated to form a multilayer.

4. The vehicle piston ring of claim 1, wherein the TiAlN/CrN nano multi-layer includes TiAlN nano layers with a thickness of at least about 10 nm to about 50 nm and CrN nano layers with a thickness of at least about 10 nm to about 50 nm which are alternately coated to form a thickness of at least about 0.1 μm to about 10 μm.

5. The vehicle piston ring of claim 1, wherein the TiAlCN layer is formed to have a thickness of at least about 0.1 μm to about 10 μm.

6. The vehicle piston ring of claim 1, wherein the TiAlCN layer contains carbon of at least about 5 at. % to about 30 at. %.

7. A piston ring having a multi-layer coating, comprising:
a buffer layer including coated over a base material of the piston ring;
an intermediate layer coated over the buffer layer;
a TiAlN/CrN nano multi-layer coated over the intermediate layer; and
a TiAlCN layer coated over the TiAlN/CrN nano multilayer to form an outermost surface layer of the piston ring.

8. The vehicle piston ring of claim 7, the buffer layer contains Ti.

9. The vehicle piston ring of claim 7, the buffer layer contains Cr.

10. The vehicle piston ring of claim 7, the intermediate layer contains Ti(C)N.

11. The vehicle piston ring of claim 7, the intermediate layer contains CrN.

12. The vehicle piston ring of claim 7, wherein the buffer layer is formed to have a thickness of at least about 0.01 μm to about 0.5 μm, and the intermediate layer is formed to have a thickness of at least about 0.1 μm to about 5 μm.

13. The vehicle piston ring of claim 7, wherein the TiAlN/CrN nano multi-layer contains TiAlN and CrN that are alternately coated to form a multilayer.

14. The vehicle piston ring of claim 7, wherein the TiAlN/CrN nano multi-layer includes TiAlN nano layers with a thickness of at least about 10 nm to about 50 nm and CrN nano layers with a thickness of at least about 10 nm to about 50 nm which are alternately coated to form a thickness of at least about 0.1 μm to about 10 μm.

15. The vehicle piston ring of claim 7, wherein the TiAlCN layer is formed to have a thickness of at least about 0.1 μm to about 10 μm.

16. The vehicle piston ring of claim 7, wherein the TiAlCN layer contains carbon of at least about 5 at. % to about 30 at. %.

17. The piston ring of claim 7, wherein the piston ring is installed in a vehicle.
